(19) United States
(12) Patent Application Publication
(10) Pub. No.: US 2026/0283248 A1
(43) Pub. Date: Sep. 24, 2026

(54) AN AEROSOL-GENERATING DEVICE HAVING A HEAT-CONDUCTING ELEMENT

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH); Julien VIDAL, Peseux (CH)

(73) Assignee: Philip Morris Products S.A., Neuchatel (CH)

(21) Appl. No.: 19/477,850

(22) PCT Filed: May 2, 2024
(86) PCT No.: PCT/EP2024/062148

§ 371 Date: Oct. 23, 2025

(30) Foreign Application Priority Data
May 2, 2023 (EP) 23171152.4

(51) Int. Cl. A24F 40/465; A24F 40/57; H05B 3/14; H05B 6/10

(52) U.S. Cl. CPC A24F 40/465; A24F 40/57; H05B 3/146; H05B 6/105

(57) ABSTRACT

An aerosol-generating device is provided, including: a heat-conducting element at least partially defining a chamber configured to receive at least a portion of an aerosol-generating article, the heat-conducting element formed from at least one of a non-electrically conductive material and a non-inductively heatable material; an inductor coil extending around at least a portion of the heat-conducting element; and a power supply and a control circuitry connected to the inductor coil and configured to provide an alternating electric current to the inductor coil such that the inductor coil generates an alternating magnetic field.

The present disclosure relates to an aerosol-generating device for receiving an aerosol-generating article, and an aerosol-generating system comprising the aerosol-generating device.

It is known to evolve an aerosol from an aerosol-forming substrate of an aerosol-generating article by the application of heat to the substrate, without burning or combustion of the substrate. The aerosol-generating article may be cylindrical, like a cigarette, and the aerosol-forming substrate may comprise tobacco material. It is known to apply heat to such an aerosol-generating article to heat the aerosol-forming substrate of the article using a heat source that is external to the aerosol-generating article.

However, an external heat source will tend to heat the aerosol-forming substrate unevenly. The aerosol-forming substrate closest to the heat source will be heated more than the aerosol-forming substrate in the centre of the aerosol-generating article, further from the heat source.

It is also known to heat the aerosol-forming substrate of such an article using a heat source located within the interior of the aerosol-forming substrate. In some aerosol-generating systems the internal heat source is heated inductively using an induction coil positioned externally of the aerosol-generating article and a susceptor material located within a central region of the aerosol-generating article. Internally heating the aerosol-forming substrate avoids heat having to traverse through a wrapper to reach the aerosol-forming substrate. However, internally heating the aerosol-forming substrate also results in the aerosol-forming substrate being heated in a non-uniform manner, with heating of the substrate being greatest at or closest to the internal heat source and reducing with increasing distance away from the internal heat source into the substrate.

Non-uniform heating of the aerosol-forming substrate can mean that not all of the available volatile material is released from the aerosol-forming substrate. This is because increasing the level of heat applied to the substrate in order to fully extract the volatile material from the aerosol-forming substrate when using either external heating or internal heating of the substrate may result in unintended and undesired burning of the substrate close to the heat source, which can give rise to the generation of undesirable compounds and flavours.

It is therefore desired to provide an aerosol-generating device that facilitates efficient and uniform heating of an aerosol-forming substrate without requiring a complex heating arrangement.

According to a first aspect of the disclosure there is provided an aerosol-generating device comprising a heat-conducting element at least partially defining a chamber for receiving at least a portion of an aerosol-generating article. The aerosol-generating device also comprises an inductor coil extending around at least a portion of the heat-conducting element. The aerosol-generating device also comprises a power supply and a control circuitry connected to the inductor coil and configured to provide an alternating electric current to the inductor coil such that, in use, the inductor coil generates an alternating magnetic field.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “heat-conducting element” is used to describe an element comprising one or more heat-conducting materials having a bulk thermal conductivity of between about 10 Watts per metre Kelvin and about 500 Watts per metre Kelvin, preferably between about 15 Watts per metre Kelvin and about 400 Watts per metre Kelvin, at 23 degrees Celsius and a relative humidity of 50 percent as measured using the modified transient plane source (MTPS) method.

The present inventors have recognised that an inductor coil may exhibit heat losses in the form of resistive heating of the inductor coil when an alternating electric current flows through the inductor coil during use. Advantageously, positioning the heat-conducting element may facilitate the transfer of resistively generated heat from the inductor coil to an aerosol-forming substrate of an aerosol-generating article received within the chamber. In embodiments in which the inductor coil is used to inductively heat a susceptor material or element positioned inside an aerosol-forming substrate, advantageously, the inductive heating of the susceptor element and the resistive heating of the inductor coil may provide simultaneous internal and external heating of the aerosol-forming substrate. Advantageously, simultaneous internal and external heating of the aerosol-forming substrate may facilitate more uniform heating of the aerosol-forming substrate.

Preferably, the inductor coil is positioned in direct contact with an outer surface of the heat-conducting element. Advantageously, direct contact between the inductor coil and the heat-conducting element may increase or maximise the conduction of resistively generated heat from the inductor coil to the heat-conducting element.

Preferably, the heat-conducting element is arranged so that, when an aerosol-generating article is inserted into the chamber, the heat-conducting element directly contacts the aerosol-generating article. Advantageously, direct contact between the heat-conducting element and an aerosol-generating article may increase or maximise the conduction of heat from the heat-conducting element to the aerosol-generating article.

Preferably, at least one of the control circuitry and the heat-conducting element is configured to prevent inductive coupling between the heat-conducting element and the inductor coil during use.

As used herein, the term “inductively couple” refers to the heating of a material when penetrated by an alternating magnetic field. The heating may be caused by the generation of eddy currents in the material. The heating may be caused by magnetic hysteresis losses.

The control circuitry may be configured to provide the alternating electric current in the form of an alternating current having a frequency selected to reduce or prevent inductive coupling between the heat-conducting element and the inductor coil during use. Preferably, the alternating current is provided at a frequency that reduces or prevents inductive coupling between the inductor coil and the heat-conducting element and increases or maximises inductive coupling between the inductor coil and a susceptor element. The frequency at which inductive coupling occurs will vary depending on the materials, physical properties and configuration of the inductor coil, the heat-conducting element and the susceptor element, such as the inductance of the inductor coil and the magnetic permeability of the material or materials from which each of the heat-conducting element and the susceptor element are formed.

The heat-conducting element may be formed from a material that reduces or prevents inductive coupling between the inductor coil and the heat-conducting element.

The heat-conducting element may be formed from a non-electrically conductive material. The non-electrically conductive material may comprise at least one of a glass, a ceramic, a silicone, a polymeric material, and a composite material comprising two or more non-electrically conductive materials.

The term “electrically conductive” is used herein to refer to materials having an electrical conductivity of at least 0.8×10⁶ Siemens per metre. The terms “non-electrically conductive” and “electrically insulating” are used herein to refer to materials having an electrical conductivity of less than 0.8×10⁴ Siemens per metre.

The heat-conducting element may be formed from a non-inductively heatable material. The non-inductively heatable material may comprise any of the non-electrically conductive materials described above. The non-inductively heatable material may comprise an electrically conductive material that exhibits poor or no inductive coupling with the inductor coil. The non-inductively heatable material may comprise a metal. The metal may comprise at least one of aluminium and a paramagnetic steel. The paramagnetic steel may comprise an austenitic steel. The heat-conducting element may be formed from a 316 stainless steel.

The heat-conducting element may have any suitable shape. Preferably, the heat-conducting element has a tubular shape. Preferably, the heat-conducting element has a circular cross-sectional shape. The heat-conducting element may have a cylindrical shape having a constant cross-sectional size. The heat-conducting element may have a cylindrical shape, wherein at least a portion of the cylindrical shape has a tapering cross-sectional size. A tapering cross-sectional size may facilitate the insertion of an aerosol-generating article into the heat-conducting element.

The heat-conducting element may be formed from a cylindrical wall of a heat-conducting material. The cylindrical wall may have a wall thickness extending in a radial direction. Preferably, the cylindrical wall has a number average thickness in the radial direction of at least 0.5 millimetres, or at least 1 millimetre, or at least 1.5 millimetres, or at least 2 millimetres. Preferably, the cylindrical wall has a number average thickness in a radial direction of less than 5 millimetres, or less than 4 millimetres, or less than 3 millimetres, or less than 2 millimetres.

The heat-conducting element may be a passive heat-conducting element. In other words, the heat-conducting element may be incapable of generating its own heat. A passive heat-conducting element is arranged only to conduct heat resistively generated by the inductor coil.

The heat-conducting element may be an active heat-conducting element. In other words, the aerosol-generating device may be configured to generate heat by resistive heating of the heat-conducting element.

In embodiments in which the heat-conducting element is an active heat-conducting element, preferably the control circuitry is configured to supply an electric current from the power supply to the heat-conducting element to resistively heat the heat-conducting element.

The heat-conducting element may comprise an electrically insulating substrate, for example a substantially tubular electrically insulating substrate, and an electrically resistive track on the electrically insulating substrate. The control circuitry may be configured to provide an electric from the power supply to the electrically resistive track in use.

Suitable electrically insulating materials may include one or more of: glass, ceramic, anodized metal, coated metal, and Polyimide. The ceramic may comprise mica, Alumina or Zirconia.

Suitable electrically resistive materials may include one or more of: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium- zirconium-, hafnium-, niobium-, molybdenum-, tantalum-, tungsten-, tin-, gallium-, manganese-and iron-containing alloys, and super-alloys based on nickel, iron, cobalt, stainless steel, Timetal® and iron-manganese-aluminium based alloys. The electrically resistive track may comprise a heating wire or filament, for example a Ni—Cr (Nickel-Chromium), platinum, tungsten or alloy wire or filament.

The heat-conducting element may comprise a polymeric material and at least one of graphite, a graphite-derived material, and hexagonal boron nitride dispersed within the polymeric material. The polymeric material may be referred to as a polymeric matrix. The at least one of graphite, a graphite-derived material, and hexagonal boron nitride may be present as filler particles in the polymeric matrix.

The polymeric material may be or comprise at least one of polyether ether ketone (PEEK) and a liquid crystal polymer (LCP). The heat-conducting element may comprise the polymeric material in an amount of between 22 percent and 33 percent by weight of the heat-conducting element.

The graphite-derived material may comprise at least one of expanded graphite and graphite nanoplatelets. The heat-conducting element may comprise the at least one of graphite, a graphite-derived material, and hexagonal boron nitride in an amount of between 62 percent and 69 percent by weight of the heat-conducting element.

The heat-conducting element may further comprise at least one additive dispersed within the polymeric material. The at least one additive may comprise carbon black. The heat-conducting element may comprise the at least one additive in an amount of between 5 percent and 9 percent by weight of the heat-conducting element. Advantageously, such an actively heated heat-conducting element may be easier to manufacture compared to other external heaters. In more detail, the inventors have observed that the thermoplastic properties of the polymeric matrix may allow the composite polymer to be tailored to be conveniently malleable, such that it lends itself to precise and controlled shaping. At the same time, by controlling and adjusting the concentration and distribution of the conductive filler particles dispersed within the polymeric matrix, it is advantageously possible to provide an active heat-conducting element capable of generating enough heat by Joule effect to efficiently heat an aerosol-forming substrate of an aerosol-generating article thermally coupled with the heat-conducting element.

Without wishing to be bound by theory, the inventors have found that by adjusting the formulation of the polymeric matrix and the degree of dispersion of the conductive filler particles within the polymeric matrix, it is possible to control the conductivity and, as a consequence, the amount of heat generated resistively by the heat-conducting element when a voltage is applied to the heat-conducting element. In particular, by adjusting the relative proportion of conductive filler to polymer within the polymer composite, it may be advantageously possible to ensure that a heat-conducting element made of the polymer composite exhibits highly desirable levels of resistivity. Other parameters, such as the length and cross-sectional surface area of the heat-conducting element may also be adjusted to fine-tune the resistive behaviour of the heat-conducting element as a whole.

Preferably, the chamber comprises an open first end through which at least a portion of an aerosol-generating article may be inserted into the chamber and a closed second end opposite the open first end.

Preferably, the aerosol-generating device comprises at least one protrusion extending into the chamber from the closed second end of the chamber. Advantageously, the at least one protrusion may abut an upstream end of an aerosol-generating article received within the chamber to space the upstream end of the aerosol-generating article apart from the closed end of the chamber. Advantageously, spacing the upstream end of the aerosol-generating article from the closed end of the chamber may facilitate airflow into the aerosol-generating article during use.

The aerosol-generating device may comprise a housing, wherein the inductor coil, the heat-conducting element, the power supply and the control circuitry are positioned within the housing. Preferably, the housing comprises an end wall defining the closed second end of the chamber, wherein the at least one protrusion extends into the chamber from the end wall. Preferably, the at least one protrusion is formed integrally with the end wall.

Preferably, the at least one protrusion comprises at least three protrusions. Advantageously, providing at least three protrusions may facilitate secure and correct positioning of an aerosol-generating article in the chamber. Preferably, the chamber has a longitudinal axis defining a first direction along which at least a portion of an aerosol-generating article may be inserted into the chamber, wherein the at least three protrusions are equidistantly spaced from each other in a circumferential direction around the longitudinal axis.

The aerosol-generating device may comprise a susceptor element. Advantageously, providing a susceptor element as part of the aerosol-generating device may eliminate the need to provide each aerosol-generating article with a susceptor element. Advantageously, this may reduce the cost of each aerosol-generating article.

As used herein, the term “susceptor element” refers to an element comprising a material that is capable of converting the energy of a magnetic field into heat. When a susceptor element is located in an alternating magnetic field, the susceptor is inductively heated. Heating of the susceptor may be the result of at least one of hysteresis losses and eddy currents induced in the susceptor, depending on the electrical and magnetic properties of the susceptor material.

Preferably, the susceptor element is an elongate susceptor element. Preferably, the elongate susceptor element extends into the chamber from the closed second end of the chamber. Preferably, at least a portion of the elongate susceptor element is positioned inside the inductor coil.

The susceptor element may be formed from any material that can be inductively heated to a temperature sufficient to aerosolise an aerosol-forming substrate. Suitable materials for the susceptor element include graphite, molybdenum, silicon carbide, stainless steels, niobium, and aluminium. Preferred susceptor elements comprise a metal or carbon. Preferably, the susceptor element comprises or consists of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than about 20 percent, more preferably more than about 50 percent or more than 90 percent of ferromagnetic or paramagnetic materials. Preferred susceptor elements may be heated to a temperature in excess of about 250 degrees Celsius.

The susceptor element may comprise a non-metallic core with a metal layer disposed on the non-metallic core. For example, the susceptor element may comprise one or more metallic tracks formed on an outer surface of a ceramic core or substrate.

The susceptor element may have a protective external layer, for example a protective ceramic layer or protective glass layer. The protective external layer may encapsulate the susceptor element. The susceptor element may comprise a protective coating formed by a glass, a ceramic, or an inert metal, formed over a core of susceptor material.

The susceptor element may have any suitable cross-section. For example, the susceptor element may have a square, oval, rectangular, triangular, pentagonal, hexagonal, or similar cross-sectional shape. The susceptor element may have a planar or flat cross-sectional shape.

The susceptor element may be solid, hollow, or porous. Preferably, the susceptor element is solid.

In embodiments in which the susceptor element has a planar or flat cross-sectional shape, preferably the susceptor element has a thickness of between about 1 millimetre and about 8 millimetres, more preferably from about 3 millimetres to about 5 millimetres. The thickness of the susceptor element is measured in a longitudinal direction of the aerosol-generating device. Preferably, the susceptor element has a width or a diameter of between about 3 millimetres and about 12 millimetres, more preferably between about 4 millimetres and about 10 millimetres, more preferably between about 5 millimetres and about 8 millimetres. The width or diameter of the susceptor element is orthogonal to its thickness.

In embodiments in which the susceptor element is an elongate susceptor element, preferably the elongate susceptor element is in the form of a pin, rod, blade, or plate. Preferably, the elongate susceptor element has a length of between about 5 millimetres and about 15 millimetres, for example between about 6 millimetres and about 12 millimetres, or between about 8 millimetres and about 10 millimetres. The elongate susceptor element preferably has a width of between about 1 millimetre and about 8 millimetres, more preferably from about 3 millimetres to about 5 millimetres. The elongate susceptor element may have a thickness of from about 0.01 millimetres to about 2 millimetres. If the elongate susceptor element has a constant cross-section, for example a circular cross-section, it has a preferable width or diameter of between about 1 millimetre and about 5 millimetres.

Preferably, the heat-conducting element is formed from a first material and the susceptor element is formed from a second material, wherein the first material is different to the second material. Advantageously, forming the heat-conducting element and the susceptor element from different materials may facilitate reduced or minimised inductive coupling between the inductor coil and the heat-conducting element and increased or maximised inductive coupling between the inductor coil and the susceptor element.

Preferably, the inductor coil is arranged so that, when an aerosol-generating article is inserted into the chamber, at least part of the aerosol-generating article is received within the inductor coil.

The inductor coil may be formed from a coiled wire. The wire may comprise an electrically conductive core and a coating on the electrically conductive core. Preferably, the coating is electrically insulating. Advantageously, an electrically insulating coating may prevent electrical short circuit between adjacent windings of the inductor coil. Advantageously, an electrically insulating coating may electrically isolate the inductor coil from the heat-conducting element. The coating may comprise at least one of a polymer, a ceramic, and a glass. The coating may comprise parylene.

The inductor coil may be formed from any suitable electrically conductive material. Preferably, the inductor coil is formed from a metal or a metal alloy. The inductor coil may be formed from at least one of copper, a copper alloy, a copper-nickel alloy, tungsten, aluminium, an aluminium alloy, and a steel. Suitable steels include stainless steels, such as 316 stainless steels. In embodiments in which the inductor coil comprises an electrically conductive core, the metal or the metal alloy may form the electrically conductive core.

The power supply may be a DC power supply. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

The power supply may be configured to operate at high frequency. As used herein, the term “high frequency oscillating current” means an oscillating current having a frequency of between about 500 kilohertz and about 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The aerosol-generating device comprises control circuitry connected to the inductor coil and the power supply. The control circuitry is configured to control the supply of power to the inductor coil from the power supply. The control circuitry may comprise a microprocessor, which may be a programmable microprocessor, a microcontroller, or an application specific integrated chip (ASIC) or other electronic circuitry capable of providing control. The control circuitry may comprise further electronic components. The control circuitry may be configured to regulate a supply of current to the inductor coil. Current may be supplied to the inductor coil continuously following activation of the aerosol-generating device or may be supplied intermittently, such as on a puff by puff basis. The control circuitry may advantageously comprise DC/AC inverter, which may comprise a Class-D or Class-E power amplifier.

The control circuitry may be configured to supply electric energy from the power supply to the inductor coil as an alternating current such that the inductor coil is operable to generate heat through one or a combination of i) resistive heating of the inductor coil and ii) heating of a susceptor element through inductive coupling of the inductor coil with the susceptor. The control circuitry may be configured to adjust at least one parameter of the alternating current to change the inductive coupling of the inductor coil with the susceptor element, thereby adjusting the balance of heat generated through inductive coupling of the inductor coil with the susceptor element relative to heat generated through resistive heating of the inductor coil.

Preferably, the at least one parameter comprises a frequency of the alternating current. The inductive coupling between the inductor coil and susceptor element varies with changes in the frequency of the alternating current. The frequency may be adjusted to have a value fsusceptor, associated with an alternating current creating an alternating magnetic field that provides optimum coupling with the susceptor element to allow transfer of almost the totality of the energy from the inductor coil to the susceptor element, resulting in most of the heat being generated by inductive heating of the susceptor element. The frequency may also be adjusted to have a value finductor coil, associated with an alternating current creating an alternating magnetic field that provides little to no coupling with the susceptor element and allows almost the totality of the energy to remain within the inductor coil, resulting in most of the heat being generated by resistive heating of the inductor coil. The frequency may also be adjusted to have a value ftotal, associated with an alternating current which results in a combination of inductive heating of the susceptor element and resistive heating of the inductor coil. Each of these frequencies will vary depending on the materials, physical properties and configuration of the inductor coil and the susceptor element, such as the inductance of the inductor coil and the magnetic permeability of the material or materials from which the susceptor element is formed.

The control circuitry may be configured to provide an alternating current to the inductor coil, such that the inductor coil generates an alternating magnetic field to inductively heat a susceptor element in an aerosol-generating article, and to provide a direct current to the inductor coil to resistively heat the inductor coil and thereby conductively heat the aerosol-generating article via the heat-conducting element. Advantageously, using a single coil to provide both heating power to an internal susceptor and to provide resistive heating of the coil itself provides two different heat sources in different locations relative to the aerosol-forming substrate with a structure that is no more complex than a typical induction heating arrangement.

The control circuitry may be configured to adjust the alternating current provided to the inductor coil during operation of the aerosol-generating device to adjust an amount of heating provided by inductive heating.

The control circuitry may be configured to adjust the direct current provided to the inductor coil during operation of the aerosol-generating device to adjust an amount of heating provided by resistive heating.

The control circuitry may be configured to provide the alternating current and the direct current to the inductor coil at different times. For example, following activation of the aerosol-generating device the control circuitry may be configured to initially provide alternating current to the inductor coil and to subsequently provide direct current to the inductor coil. This may provide for rapid generation of aerosol at the outset of a usage session, but also provide for complete and efficient heating of the entire aerosol-forming substrate over a full usage session. At the beginning of a usage session, inductive heating of an internal susceptor may provide aerosol more quickly than external resistive heating because the susceptor can be in closer contact with the aerosol-forming substrate. An internal susceptor may also be heated more quickly than the external inductor coil if the susceptor has a lower thermal mass than the inductor coil.

The control circuitry may be configured to provide the alternating current and the direct current to the inductor coil in an alternating sequence. It may be beneficial to alternate external and internal heating in order to avoid overheating of any part of the aerosol-forming substrate.

The control circuitry may be configured to provide both alternating current and direct current to the inductor coil concurrently. In this way a larger amount of heat energy can be transferred to the aerosol-forming substrate to generate a larger volume of aerosol, without either the susceptor or the inductor coil reaching a temperature at which any part of the aerosol-generating article might combust.

An aerosol-generating device comprising control circuitry configured to vary at least one parameter of an alternating electric current, or configured to provide both alternating current and direct current to the inductor coil, is able to change the mode of application of heat to an aerosol-forming substate according to any one of the following heating regimes:
a) solely or predominantly through the resistive heating of the inductor coil;
b) solely or predominantly through heating of a susceptor element through the inductive coupling of the inductor coil with the susceptor element;
c) a combination of resistive heating of the inductor coil and heating of a susceptor element through the inductive coupling of the inductor coil with the susceptor element.

Preferably, the aerosol-generating device is portable. The aerosol-generating device may have a size comparable to a conventional cigar or cigarette. The aerosol-generating device may have a total length between approximately 30 millimetres and approximately 150 millimetres. The aerosol-generating device may have an external diameter between approximately 5 millimetres and approximately 30 millimetres.

The aerosol-generating device housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise a mouthpiece. The mouthpiece may comprise at least one air inlet and at least one air outlet. The mouthpiece may comprise more than one air inlet. One or more of the air inlets may reduce the temperature of the aerosol before it is delivered to a user and may reduce the concentration of the aerosol before it is delivered to a user.

Alternatively, the mouthpiece may be provided as part of an aerosol-generating article.

As used herein, the term “mouthpiece” refers to a portion of an aerosol-generating device that is placed into a user's mouth in order to directly inhale an aerosol generated by the aerosol-generating device from an aerosol-generating article received in the chamber of the housing.

The aerosol-generating device may include a user interface to activate the device, for example a button to initiate heating of the device or display to indicate a state of the device or of the aerosol-forming substrate.

According to a second aspect of the present disclosure there is provided an aerosol-generating system. The aerosol-generating system comprises an aerosol-generating device according to the first aspect of the present disclosure, in accordance with any of the embodiments described herein. The aerosol-generating system also comprises an aerosol-generating article comprising an aerosol-forming substrate.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-forming substrate” refers to a substrate consisting of or comprising an aerosol-forming material that is capable of releasing volatile compounds upon heating to generate an aerosol.

The aerosol-generating article may comprise an article susceptor element. Preferably, the article susceptor element is positioned in direct contact with the aerosol-forming substrate. Preferably, the article susceptor element is an internal susceptor element positioned within the aerosol-forming substrate.

Preferably, the aerosol-generating article is configured so that at least a portion of the article susceptor element is positioned within the inductor coil when the aerosol-generating article is inserted into the chamber of the aerosol-generating device.

The article susceptor element may comprise any of the optional or preferred features described above with respect to a susceptor element forming part of the aerosol-generating device.

Preferably, the heat-conducting element is formed from a first material and the article susceptor element is formed from a second material, wherein the first material is different to the second material. Advantageously, forming the heat-conducting element and the article susceptor element from different materials may facilitate reduced or minimised inductive coupling between the inductor coil and the heat-conducting element and increased or maximised inductive coupling between the inductor coil and the article susceptor element.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device comprising:
a heat-conducting element at least partially defining a chamber for receiving at least a portion of an aerosol-generating article;
an inductor coil extending around at least a portion of the heat-conducting element; and
a power supply and a control circuitry connected to the inductor coil and configured to provide an alternating electric current to the inductor coil such that, in use, the inductor coil generates an alternating magnetic field.

Example Ex2: An aerosol-generating device according to Example 1, wherein the inductor coil is positioned in direct contact with an outer surface of the heat-conducting element.

Example Ex3: An aerosol-generating device according to Example 1 or 2, wherein the heat-conducting element is arranged so that, when an aerosol-generating article is inserted into the chamber, the heat-conducting element directly contacts the aerosol-generating article.

Example Ex4: An aerosol-generating device according to Example 1, 2 or 3, wherein at least one of the control circuitry and the heat-conducting element is configured to prevent inductive coupling between the heat-conducting element and the inductor coil during use.

Example Ex5: An aerosol-generating device according to any preceding Example, wherein the control circuitry is configured to provide the alternating electric current in the form of an alternating current having a frequency selected to prevent inductive coupling between the heat-conducting element and the inductor coil during use.

Example Ex6: An aerosol-generating device according to any preceding Example, wherein the heat-conducting element is formed from a non-electrically conductive material.

Example Ex7: An aerosol-generating device according to any preceding Example, wherein the heat-conducting element is formed from a non-inductively heatable material.

Example Ex8: An aerosol-generating device according to any preceding Example, wherein the heat-conducting element comprises at least one of a polymeric material and a metal.

Example Ex9: An aerosol-generating device according to any preceding Example, wherein the heat-conducting element comprises at least one of aluminium and a paramagnetic steel.

Example Ex10: An aerosol-generating device according to Example 9, wherein the paramagnetic steel comprises an austenitic steel.

Example Ex11: An aerosol-generating device according to any preceding Example, wherein the heat-conducting element comprises a polymeric material and at least one of graphite, a graphite-derived material, and hexagonal boron nitride dispersed within the polymeric material.

Example Ex12: An aerosol-generating device according to Example 11, wherein the polymeric material comprises at least one of polyether ether ketone (PEEK) and a liquid crystal polymer (LCP).

Example Ex13: An aerosol-generating device according to Example 11 or 12, wherein the heat-conducting element comprises the polymeric material in an amount of between 22 percent and 33 percent by weight of the heat-conducting element.

Example Ex14: An aerosol-generating device according to Example 11, 12 or 13, wherein the graphite-derived material comprises at least one of expanded graphite and graphite nanoplatelets.

Example Ex15: An aerosol-generating device according to any of Examples 11 to 14, wherein the heat-conducting element comprises the at least one of graphite, a graphite-derived material, and hexagonal boron nitride in an amount of between 62 percent and 69 percent by weight of the heat-conducting element.

Example Ex16: An aerosol-generating device according to any of Examples 11 to 15, wherein the heat-conducting element further comprises at least one additive dispersed within the polymeric material.

Example Ex17: an aerosol-generating device according to Example 16, wherein the at least one additive comprises carbon black.

Example Ex18: An aerosol-generating device according to Example 16 or 17 wherein the heat-conducting element comprises the at least one additive in an amount of between 5 percent and 9 percent by weight of the heat-conducting element.

Example Ex19: An aerosol-generating device according to any preceding Example, wherein the power supply and the control circuitry are connected to the heat-conducting element and configured to provide an electric current to the heat-conducting element during use to resistively heat the heat-conducting element.

Example Ex20: An aerosol-generating device according to any preceding Example, wherein the chamber comprises an open first end through which at least a portion of an aerosol-generating article may be inserted into the chamber and a closed second end opposite the open first end.

Example Ex21: An aerosol-generating device according to the Example 20, further comprising at least one protrusion extending into the chamber from the closed second end of the chamber.

Example Ex22: An aerosol-generating device according to Example 21, wherein the at least one protrusion comprises at least three protrusions.

Example Ex23: An aerosol-generating device according to Example 22, wherein the chamber has a longitudinal axis defining a first direction along which at least a portion of an aerosol-generating article may be inserted into the chamber, and wherein the at least three protrusions are equidistantly spaced from each other in a circumferential direction around the longitudinal axis.

Example Ex24: An aerosol-generating device according to any preceding Example, further comprising a housing, wherein the inductor coil, the heat-conducting element, the power supply and the control circuitry are positioned within the housing.

Example Ex25: An aerosol-generating device according to the combination of Example 24 with any of Examples 20 to 23, wherein the housing comprises an end wall defining the closed second end of the chamber, and wherein the at least one protrusion extends into the chamber from the end wall.

Example Ex26: An aerosol-generating device according to Example 25, wherein the at least one protrusion is formed integrally with the end wall.

Example Ex27: An aerosol-generating device according to any of Examples 20 to 26, further comprising an elongate susceptor element extending into the chamber from the closed second end of the chamber.

Example Ex28: An aerosol-generating device according to Example 27, wherein at least a portion of the elongate susceptor element is positioned inside the inductor coil.

Example Ex29: An aerosol-generating device according to Example 27 or 28, wherein the heat-conducting element is formed from a first material, wherein the elongate susceptor element is formed from a second material, and wherein the first material is different to the second material.

Example Ex30: An aerosol-generating device according to any preceding Example, wherein the inductor coil is arranged so that, when an aerosol-generating article is inserted into the chamber, at least part of the aerosol-generating article is received within the inductor coil.

Example Ex31: An aerosol-generating system comprising:
an aerosol-generating device according to any preceding Example; and
an aerosol-generating article comprising an aerosol-forming substrate.

Example Ex32: An aerosol-generating system according to Example 31, wherein the aerosol-generating article is configured so that at least a portion of the aerosol-forming substrate is positioned within the heat-conducting element when the aerosol-generating article is inserted into the chamber.

Example Ex33: An aerosol-generating system according to Example 31 or 32, wherein the aerosol-generating article further comprises an article susceptor element.

Example Ex34: An aerosol-generating system according to Example 33, wherein the aerosol-generating article is configured so that at least a portion of the article susceptor element is positioned within the inductor coil when the aerosol-generating article is inserted into the chamber.

Example Ex35: An aerosol-generating system according to Example 33 or 34, wherein the heat-conducting element is formed from a first material, wherein the article susceptor element is formed from a second material, and wherein the first material is different to the second material.

The invention is further described, by way of example only, with reference to the accompanying drawings in which:

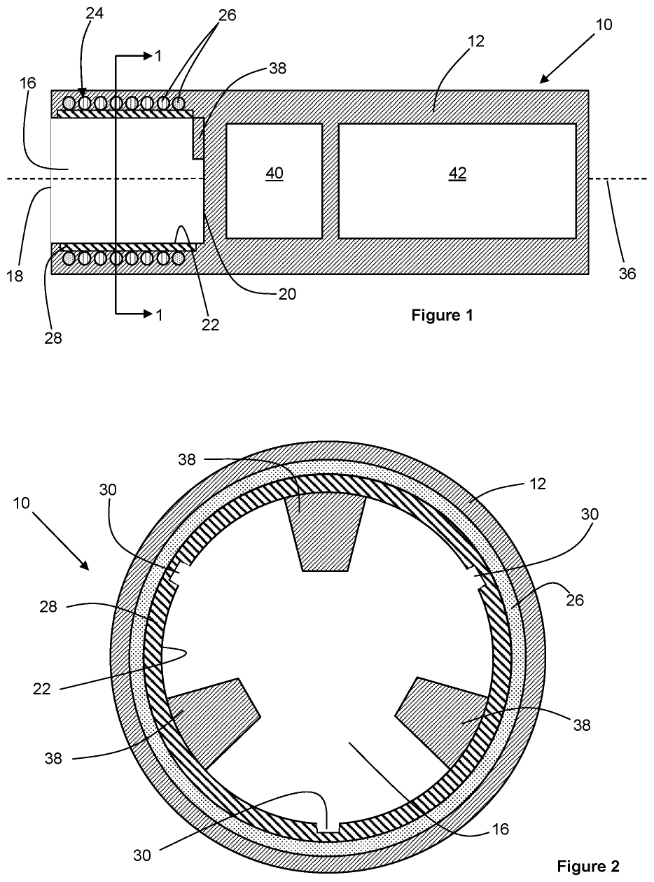

FIG. 1 shows a side cross-sectional view of an aerosol-generating device according to a first embodiment of the present invention;

FIG. 2 shows an axial cross-sectional view of the aerosol-generating device of FIG. 1 along line 1-1;

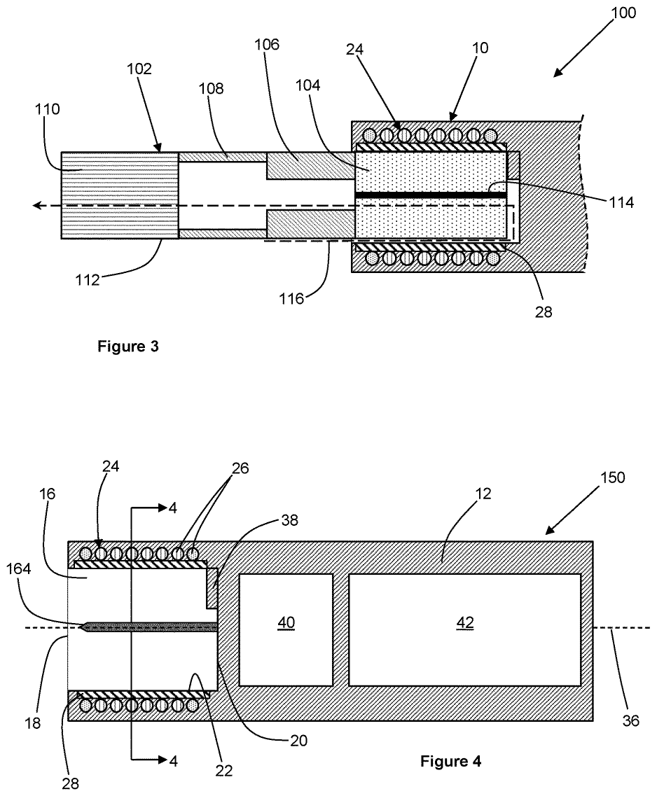

FIG. 3 shows a side cross-sectional view of an aerosol-generating system comprising the aerosol-generating device of FIG. 1;

FIG. 4 shows a side cross-sectional view of an aerosol-generating device according to a second embodiment of the present invention; and

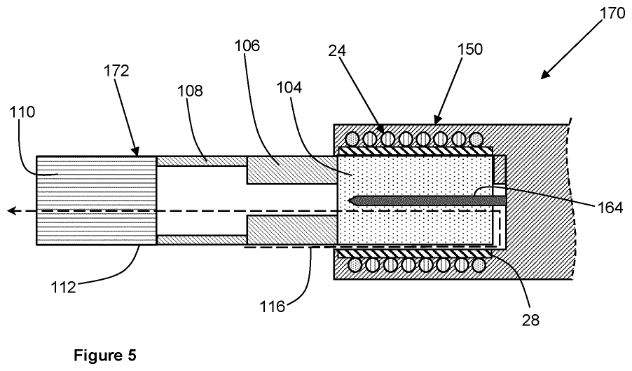

FIG. 5 shows a side cross-sectional view of an aerosol-generating system comprising the aerosol-generating device of FIG. 4.

FIGS. 1 and 2 show an aerosol-generating device 10 in accordance with a first embodiment of the present invention. The aerosol-generating device 10 comprises a housing 12 partially defining a chamber 16 for receiving a portion of an aerosol-generating article. The chamber 16 comprises an open end 18 through which an aerosol-generating article may be inserted into the chamber 16 and a closed end 20 opposite the open end 18.

The aerosol-generating device also comprises a heat-conducting element 28 in the form of an austenitic steel tube. The heat-conducting element 28 partially defines a cylindrical wall 22 of the chamber 16 that extends between the open end 18 and the closed end 20. The heat-conducting element 28 is arranged so that an aerosol-generating article is received within the heat-conducting element 28 and in direct contact with the heat-conducting element 28 when the aerosol-generating article is inserted into the chamber 16. Advantageously, direct contact between the heat-conducting element 28 and an aerosol-generating article facilitates the transfer of heat from the heat-conducting element 28 to the aerosol-generating article.

An inductor coil 24 comprising a plurality of windings 26 extends around an outer surface of the heat-conducting element 28. The inductor coil 24 is arranged so that the plurality of windings are in direct contact with the outer surface of the heat-conducting element 28. Advantageously, positioning the inductor coil 24 in direct contact with an outer surface of the heat-conducting element 28 facilitates the transfer of heat generated by resistive heating of the inductor coil 24 to the heat-conducting element 28. The inductor coil 24 and the heat-conducting element 28 are arranged concentrically about a central axis 36 of the aerosol-generating device 10.

As shown in FIG. 2, the heat-conducting element 28 defines a plurality of channels 30 in an inner surface of the heat-conducting element. Advantageously, the channels 30 facilitate airflow through the chamber 16 when an aerosol-generating article is received within the chamber 16. In the embodiment shown in FIGS. 1 and 2, the heat-conducting element 28 defines three channels 30 spaced equidistantly about the central axis 36 of the aerosol-generating device 10. The skilled person will appreciate that the heat-conducting element 28 may define more or fewer channels 30 and the arrangement of the protrusions 38 about the central axis 36 may be varied.

The housing 12 also defines a plurality of protrusions 38 extending into the chamber 16 from the closed end 20 of the chamber 16. As will be further described below, the plurality of protrusions 38 function to maintain a gap between an end of an aerosol-generating article and the closed end 20 of the chamber 16 when the aerosol-generating article is fully inserted into the chamber 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the chamber 16 may be varied.

The aerosol-generating device 10 also comprises a control circuitry 40 and a power supply 42 connected to the inductor coil 24. The control circuitry 40 is configured to provide an alternating electric current from the power supply 42 to the inductor coil 24 to generate an alternating magnetic field.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 so that the aerosol-forming substrate 104 and the susceptor element 114 are positioned inside the heat-conducting element 28 and the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol. Additionally, heat generated in the inductor coil 24 itself by resistive losses in the inductor coil 24 is conducted from the inductor coil 24 to the aerosol-forming substrate 104 by the heat-conducting element 28.

Airflow through the aerosol-generating system 100 during use is illustrated by the dashed line 116 in FIG. 3. When a user draws on the mouthpiece 110 of the aerosol-generating article 102, a negative pressure is generated in the chamber 16. The negative pressure draws air into the chamber 16 at the open end 18 of the chamber. The air entering the chamber 16 then flows along the plurality of channels 30 defined by the heat-conducting element 28. When the airflow reaches the closed end 20 of the chamber 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the chamber 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 4 shows a cross-sectional view of an aerosol-generating device 150 according to a second embodiment of the invention. The aerosol-generating device 150 is similar to the aerosol-generating device 10 described with reference to FIGS. 1 and 2 and like reference numerals are used to designate like parts.

The aerosol-generating device 150 differs from the aerosol-generating device 10 by the addition of a susceptor element 164. The susceptor element 164 has an elongate shape and extends into the chamber 16 from the closed end 20 of the chamber 16. The susceptor element 164 extends along the central axis 36 of the aerosol-generating device 150 so that the inductor coil 24 and the heat-conducting element 28 extend concentrically around the susceptor element 164.

FIG. 5 shows a cross-sectional view of an aerosol-generating system 170 comprising the aerosol-generating device 150 of FIG. 4 and an aerosol-generating article 172. The aerosol-generating system 170 is similar to the aerosol-generating system 100 described with reference to FIG. 3 and like reference numerals are used to designate like parts.

The aerosol-generating system 170 differs by the absence of a susceptor element in the aerosol-generating article 172. When the aerosol-generating article 172 is inserted into the chamber 16, the susceptor element 164 of the aerosol-generating device 150 is received within the aerosol-forming substrate 104 of the aerosol-generating article 172. Once the aerosol-generating article 172 has been inserted into the chamber 16, the operation of the aerosol-generating system 170 is identical to the operation of the aerosol-generating system 100 described with reference to FIG. 3.

1-16. (canceled)

17. An aerosol-generating device, comprising:
a heat-conducting element at least partially defining a chamber configured to receive at least a portion of an aerosol-generating article, the heat-conducting element formed from at least one of a non-electrically conductive material and a non-inductively heatable material;
an inductor coil extending around at least a portion of the heat-conducting element; and
a power supply and a control circuitry connected to the inductor coil and configured to provide an alternating electric current to the inductor coil such that the inductor coil generates an alternating magnetic field.

18. The aerosol-generating device according to claim 17, wherein the power supply and the control circuitry are connected to the heat-conducting element and further configured to provide an electric current to the heat-conducting element to resistively heat the heat-conducting element.

19. An aerosol-generating device, comprising:
a heat-conducting element at least partially defining a chamber configured to receive at least a portion of an aerosol-generating article;
an inductor coil extending around at least a portion of the heat-conducting element; and
a power supply and a control circuitry, wherein the power supply and the control circuitry are connected to the inductor coil and configured to provide an alternating electric current to the inductor coil such that the inductor coil generates an alternating magnetic field, and
wherein the power supply and the control circuitry are connected to the heat-conducting element and configured to provide an electric current to the heat-conducting element to resistively heat the heat-conducting element.

20. The aerosol-generating device according to claim 19, wherein the heat-conducting element is formed from at least one of a non-electrically conductive material and a non-inductively heatable material.

21. The aerosol-generating device according to claim 17, wherein the inductor coil is positioned in direct contact with an outer surface of the heat-conducting element.

22. The aerosol-generating device according to claim 17, wherein the heat-conducting element is arranged so that, when the aerosol-generating article is inserted into the chamber, the heat-conducting element directly contacts the aerosol-generating article.

23. The aerosol-generating device according to claim 17, wherein at least one of the control circuitry and the heat-conducting element is further configured to prevent inductive coupling between the heat-conducting element and the inductor coil.

24. The aerosol-generating device according to claim 17, wherein the control circuitry is further configured to provide the alternating electric current in the form of an alternating current having a frequency selected to prevent inductive coupling between the heat-conducting element and the inductor coil.

25. The aerosol-generating device according to claim 17, wherein the heat-conducting element comprises at least one of a polymeric material and a metal.

26. The aerosol-generating device according to claim 17, wherein the heat-conducting element comprises at least one of aluminium and a paramagnetic steel.

27. The aerosol-generating device according to claim 17, wherein the heat-conducting element comprises at least one of aluminium and an austenitic steel.

28. The aerosol-generating device according to claim 17, wherein the chamber comprises an open first end through which at least the portion of the aerosol-generating article is configured to be inserted into the chamber and a closed second end opposite the open first end.

29. The aerosol-generating device according to claim 28, wherein the aerosol-generating device further comprises at least one protrusion extending into the chamber from the closed second end of the chamber.

30. The aerosol-generating device according to claim 17, further comprising a susceptor element.

31. The aerosol-generating device according to claim 30,
wherein the heat-conducting element is formed from a first material,
wherein the susceptor element is formed from a second material, and
wherein the first material is different from the second material.

32. An aerosol-generating system, comprising:
the aerosol-generating device according to claim 17; and
an aerosol-generating article comprising an aerosol-forming substrate.

33. The aerosol-generating system according to claim 32, wherein the aerosol-generating article further comprises an article susceptor element.

34. The aerosol-generating system according to claim 33,
wherein the heat-conducting element is formed from a first material,
wherein the article susceptor element is formed from a second material, and
wherein the first material is different from the second material.
